(19) United States
(12) Patent Application Publication
(10) Pub. No.: US 2008/0313554 A1
(43) Pub. Date: Dec. 18, 2008

(54) Apparatus, method, computer program and user interface for storing information

(75) Inventors: Christian Ostergaard, Vaerlose (DK); Franco Montebovi, Lund (SE)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 11/820,090

(22) Filed: Jun. 18, 2007

(51) Int. Cl. G06F 3/048; G06F 17/30

(52) U.S. Cl. 715/764; 707/1; 707/E17.008

(57) ABSTRACT

An apparatus including: a memory for storing files in a storage system including a plurality of folders; a display for presenting the plurality of folders and the files stored in the plurality of folders to a user of the apparatus; a user input device for enabling a user to designate a folder as a destination folder and for enabling a user to select a file to be transferred from a first folder to the designated destination folder; a processor configured to determine, in response to user selection of a file in a first folder, if a destination folder has been designated by a user and, if a destination folder has been designated by a user, to transfer the selected file from the first folder to the designated destination folder, and if a destination folder has not been designated by a user to enable a user to designate a destination folder and to transfer the selected file to the designated destination folder.

### FIELD OF THE INVENTION

Embodiments of the present invention relate to an apparatus, method, computer program and user interface for storing information. In particular, they relate to an apparatus, method, computer program and user interface for storing information in a storage system comprising a plurality of folders.

### BACKGROUND TO THE INVENTION

Many electronic devices comprise storage systems which enable a plurality of files to be stored in a plurality of different folders or directories. A file is an entity of data that is available to the user of the device or to the processor of the device and is capable of being manipulated, for example by being moved from one folder to another, as an entity. A folder is a collection of files that can be retrieved, moved and otherwise manipulated as one entity. A folder may also comprise other folders.

A user of an apparatus often needs to transfer files from one folder to another or even, the complete content of one folder to another folder. A file may be transferred by moving the file from a first folder to a second folder or by copying the file from the first folder to the second folder. It would be beneficial to provide a quick and simple way of enabling a user to transfer files between folders.

### BRIEF DESCRIPTION OF THE INVENTION

According to some embodiments of the invention there is provided an apparatus comprising: a memory for storing files in a storage system comprising a plurality of folders; a display for presenting the plurality of folders and the files stored in the plurality of folders to a user of the apparatus; a user input device for enabling a user to designate a folder as a destination folder and for enabling a user to select a file to be transferred from a first folder to the designated destination folder; a processor configured to determine, in response to user selection of a file in a first folder, if a destination folder has been designated by a user and, if a destination folder has been designated by a user, to transfer the selected file from the first folder to the designated destination folder, and if a destination folder has not been designated by a user to enable a user to designate a destination folder and to transfer the selected file to the designated destination folder.

This provides the advantage that it enables a user to easily transfer files between folders. The number of user inputs required to transfer a file is reduced because once a destination folder has been designated files selected for transfer are automatically transferred to the destination folder designated by the user.

In some embodiments of the invention, once a file has been transferred to the designated destination folder the folder remains designated as the destination folder so that any subsequent files selected for transfer will be transferred to the designated destination folder. This provides the advantage that it reduces the number of user inputs required to transfer a plurality of files, which may be stored in a plurality of different folders, to a destination folder as the user only has to designate a destination folder once.

According to some embodiments of the invention there is provided a method comprising: storing files in a storage system comprising a plurality of folders on an electronic apparatus; selecting a file to be transferred from a first folder; in response to selection of the file determining if a destination folder has been designated by a user; and if a destination folder has been designated by a user, transferring the selected file from the first folder to the designated destination folder, and if a destination folder has not been designated by a user, enabling a user to designate a destination folder and transfer the selected file to the designated destination folder.

According to another embodiment of the invention there is provided a computer program comprising program instructions for controlling an apparatus, the apparatus comprising, a memory for storing files in a storage system comprising a plurality of folders, a display for presenting the plurality of folders and the files stored in the plurality of folders to a user of the apparatus, and a user input device for enabling a user to designate a folder as a destination folder and for enabling a user to select a file to be transferred from a first folder to the designated destination folder, the program instructions providing, when loaded into a processor: means for determining, in response to selection of a file stored in a first folder, if a destination folder has been designated by a user; and if a destination folder has been designated by a user, means for transferring the selected file from the first folder to the designated destination folder, and if a destination folder has not been designated by a user, means for enabling a user to designate a destination folder and transfer the selected file to the designated destination folder.

According to another embodiment of the invention there is provided a user interface comprising: a display for presenting a plurality files stored in a storage system comprising a plurality of folders; a user input device for enabling a user to designate a folder as a destination folder and for enabling a user to select a file to be transferred from a first folder to the designated destination folder; wherein, in response to user selection of a file in a first folder, if a destination folder has been designated by a user the selected file is transferred from the first folder to the destination folder and if a destination folder has not been designated the user interface enables a user to designate a destination folder and transfer the selected file to the designated destination folder.

According to another embodiment of the invention there is provided an apparatus comprising: a memory for storing files in a storage system comprising a plurality of folders; a display for presenting the plurality of folders and the files stored in the plurality of folders to a user of the apparatus; a user input device for enabling a user to designate a folder as a destination folder and for enabling a user to select a file to be transferred from a first folder to the designated destination folder; a processor configured, in response to user selection of a file in a first folder, to automatically transfer a file from the first folder to the user designated destination folder.

This provides the advantage that it reduces the number of user inputs required to transfer a file or a plurality of files from the first folder to the destination folder because no further user input is required once the file or files to be transferred have been selected.

The apparatus may be for wireless communication, or storing of information such as digital images or audio files etc.

### BRIEF DESCRIPTION OF THE DRAWINGS

For a better understanding of the present invention reference will now be made by way of example only to the accompanying drawings in which:

FIG. 1 schematically illustrates an electronic device;

FIG. 2. illustrates a flow chart showing method steps of an embodiment of the present invention;

FIGS. 3A to 3G illustrate an embodiment of the present invention in use; and

FIGS. 4A to 4F illustrate a second embodiment of the invention in use.

### DETAILED DESCRIPTION OF EMBODIMENTS OF THE INVENTION

The Figures illustrate an apparatus 1 comprising: a memory 5 for storing files 10 in a storage system 6 comprising a plurality of folders 8; a display 11 for presenting the plurality of folders 8 and the files 10 stored in the plurality of folders 8 to a user of the apparatus 1; a user input device 9 for enabling a user to designate a folder 10 as a destination folder and for enabling a user to select a file 8 to be transferred from a first folder to the designated destination folder; a processor 3 configured to determine 25, in response to user selection 23 of a file in a first folder, if a destination folder has been designated by a user and, if a destination folder has been designated by a user, to transfer 27 the selected file from the first folder to the designated destination folder, and if a destination folder has not been designated by a user to enable a user to designate 29 a destination folder and to transfer 27 the selected file to the designated destination folder.

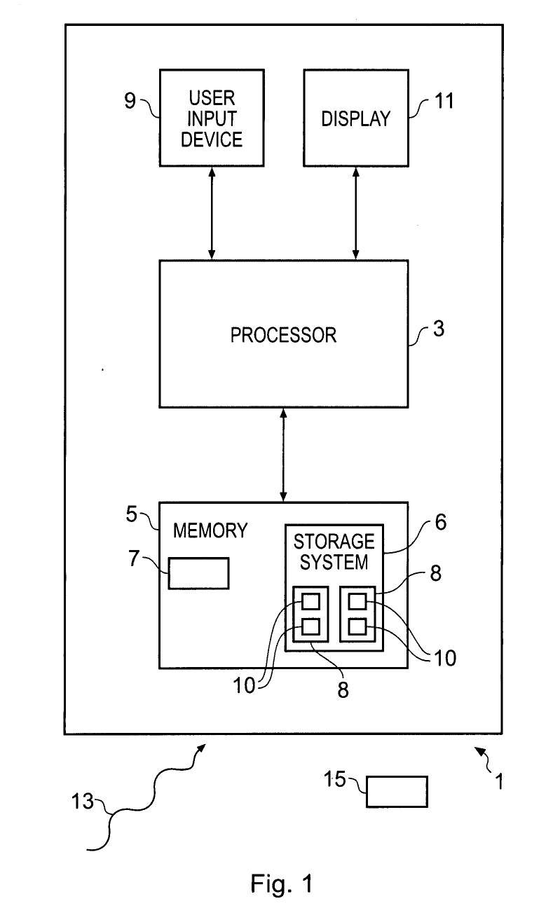

FIG. 1 schematically illustrates an electronic device 1. Only the features referred to in the following description are illustrated. It should, however, be understood that the device 1 may comprise additional features that are not illustrated. The electronic device 1 may be, for example, a personal computer, a personal digital assistant, a mobile cellular telephone, a digital camera, a personal music player or any other electronic device that enables files to be stored in a storage system comprising a plurality of folders.

The illustrated electronic device 1 comprises: a user input device 9, a memory 5, a display 11 and a processor 3. The processor 3 is connected to receive input commands from the user input device 9 and to provide output commands to the display 11. The processor 3 is also connected to write to and read from the memory 5.

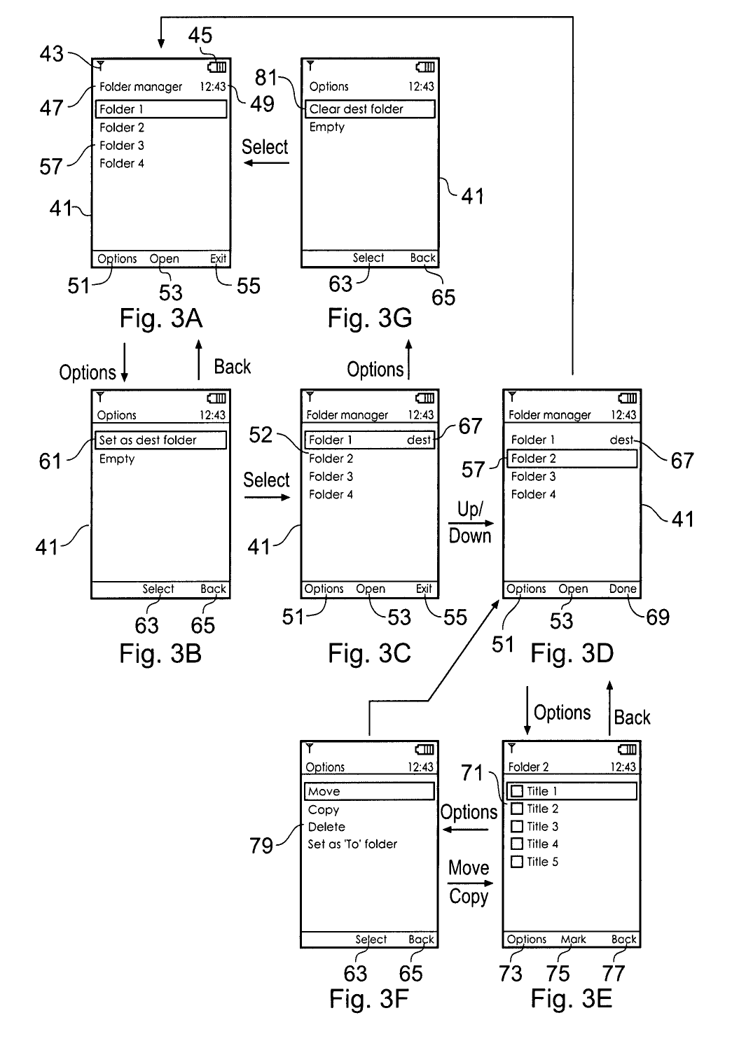

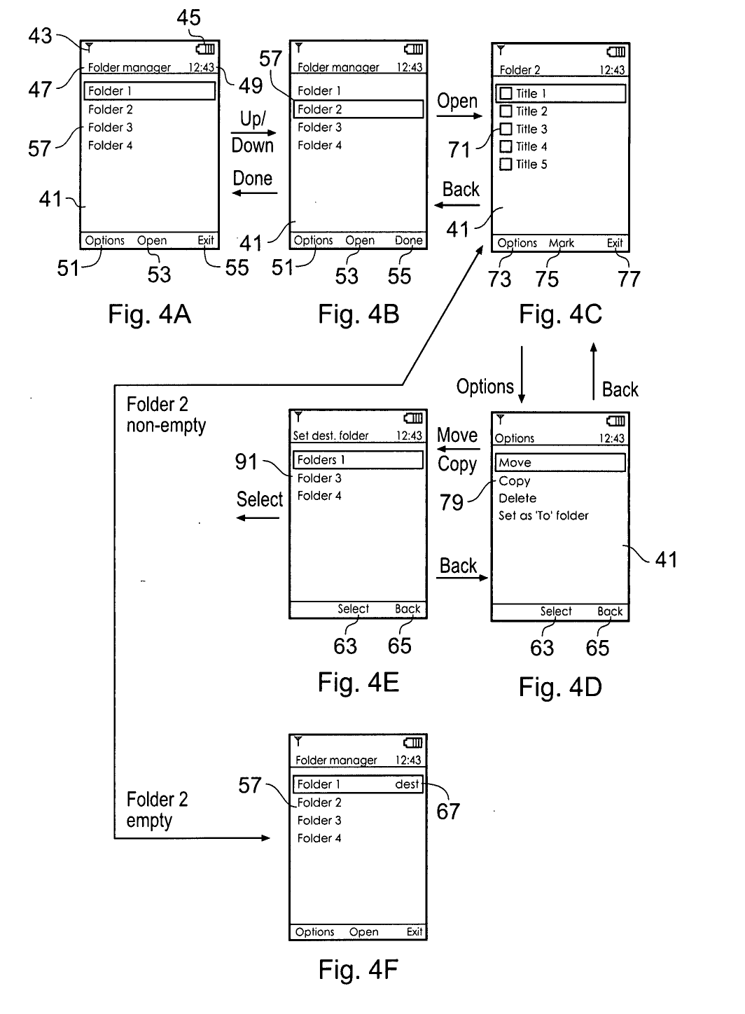

The display 11 presents a graphical user interface to a user. Examples of a graphical user interface according to embodiments of the invention are illustrated in FIGS. 3 and 4.

The memory 5 comprises a storage system 6 which comprises a plurality of folders 10. A plurality of files 10 can be stored in the folders 8 of the storage system 6 and can be moved or copied between the folders 8.

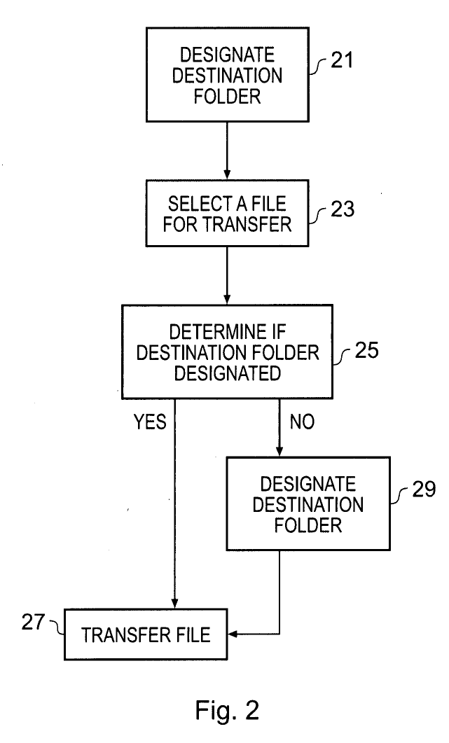

The memory 5 also stores computer program instructions 7, which when loaded into the processor 3, enable the processor 3 to control the operation of the device 1 as described below. The computer program instructions 7 provide the logic and routines that enables the electronic device 1 to perform the method illustrated in FIG. 2.

The computer program instructions 7 may arrive at the electronic device 1 via an electromagnetic carrier signal 13 or be copied from a physical entity 15 such as a computer program product, a memory device or a record medium such as a CD-ROM or DVD.

A method of controlling the device 1, according to embodiments of the present invention, is illustrated schematically in FIG. 2.

At block 21 a user of the device 1 designates a folder 8 as the destination folder using the user input device 9. A user may designate a folder 8 as the destination folder by selecting one of a plurality of user selectable options which are associated with a folder 8 and which are presented to the user on the display 11.

Block 21 is an optional block of the method. In some embodiments of the invention block 21 may be missed out.

At block 23 the user selects a file stored in a first folder. The first folder may be a different folder to the destination folder or it may be the same folder. A user may select a file for transfer by selecting one of a number of user selectable options which are associated with a file and which are presented to the user on the display 11. A file may be transferred from a first folder to the destination folder by being moved or by being copied. The user of the device 1 may be able to select whether they would like the file to be copied or to be moved.

In response to the selection of a file for transfer at block 23 the processor 3 determines, at block 25, whether or not a destination folder has been designated by a user.

If a destination folder has been designated by a user, for example, if a user selected a destination folder at block 21, then the file selected for transfer is automatically transferred, at block 25, from the first folder to the user designated destination folder. When a file is automatically transferred no further user input is required once the file to be transferred has been selected by the user.

If the processor 3 determines, at block 25, that a destination folder has not been designated by a user of the device 1 then, at block 29, the processor 3 enables a user to designate a destination folder. For example, the processor 3 may control the display 11 to present a list of the folders which are available for designation as a destination folder and enable the user input device 9 to be used to select a folder from that list. Once a user has designated 29 a destination folder the processor 3 will then transfer the file, at block 27, to the designated destination folder without requiring any further user input.

Once the file has been transferred the user designated destination folder will remain as the designated destination folder. If a user selects another file to be transferred then the processor 3 will determine that the previously designated destination folder is still the destination folder and will automatically transfer the selected file to the previously designated destination folder.

A user may be able to undesignate a folder as the destination folder. This may be done by selecting one of a number of user selectable options associated with a folder or by designating a different folder as the destination folder.

FIG. 3 illustrates an embodiment of the invention in use in a device 1 which is operable as a communication device. In the embodiment illustrated in FIG. 3 the destination folder is designated by a user before the file to be transferred is selected.

FIG. 3A illustrates a graphical user interface 41 which is presented to a user of the device 1 on the display 11. In this particular embodiment the graphical user interface 41 comprises a plurality of icons 43, 45, 47 and 49.

Icon 43 indicates the signal strength received by the communication device. Icon 45 indicates the power remaining in the battery of the device 1. Icon 47 indicates the application or function of the device which is currently being used, in the graphical user interface illustrated in FIG. 3A the device 1 is using folder manager. Icon 49 indicates the time.

In FIG. 3A the device is in a folder manager application. A list 57 of the available folders is presented and “Folder 1” is highlighted. A user may be able to scroll through the list 57 of folders using the user input 9. Scrolling through the list 57 will cause the other folders in the list to be highlighted.

The graphical user interface 41 also comprises a number of legends “Options” 51, “Open” 53 and “Exit” 55. The positions of these legends 51, 53 and 55 correspond to the position of programmable user inputs of the user input device 9. For example the legends 51, 53 and 55 may be positioned above keys in a key pad or the legends may be positioned in a touch sensitive area of the display 11. The legends 51, 53 and 55 indicate the functions associated with the programmable user inputs and are dependent upon the status of the device 1.

Selecting “Open” 55 causes the highlighted folder to be opened. Selecting “Exit” 55 causes the processor to exit the folder manager application. Selecting “Options” 51 when “Folder 1” is highlighted causes the processor 3 to control the display 11 to present a list 61 of user selectable options associated with folder 1, as illustrated in FIG. 3B.

In FIG. 3B the legends associated with the programmable user inputs have changed. Selecting the legend “Select” 63 causes the highlighted option in the list 61 to be selected, selecting the legend “Back” 65 causes the device 1 to return to the graphical user interface 41 illustrated in FIG. 3A.

The list 61 of user selectable options associated with folder 1 comprises “Set as destination folder” and “Empty”. Selecting the option “Set as destination folder” designates folder 1 as the destination folder. After folder 1 has been designated as the destination folder the processor 3 will then control the display 11 present the graphical user interface 41 comprising the list 57 of folders as illustrated in FIG. 3C. This graphical user interface 41 is the same as the graphical user interface 41 illustrated in FIG. 3A except that an icon 67 is presented next to Folder 1 in the list 57 to indicate to a user that folder 1 has been designated as the destination folder. The legends 51, 53 and 55 and the functions associated with them are the same as in FIG. 3A.

FIG. 3D illustrates the same graphical user interface as FIG. 3C except that the user has used the user input device 9 to scroll through the list 57 of folders so that “Folder 2” is now highlighted. The legend “Exit” 55 is replaced with the legend “Done” 69. Selecting the option “Done” 69 causes the designated destination folder to be undesignated and the device 1 to return to the graphical user interface illustrated in FIG. 3A.

Selecting the legend “Open” 53 causes the processor 3 to open the highlighted folder, Folder 2, and control the display 11 to display the graphical user interface 41 illustrated in FIG. 3E.

The graphical user interface 41 illustrated in FIG. 3E comprises a list 71 of the files stored in folder 2. The legends “Options” 73, “Mark” 75 and “Back” 77 associated with the programmable user inputs are different to the legends in FIG. 3D. Selecting “Options” 73 causes the processor 3 to control the display 11 to present the list 79 of user selectable options associated with the highlighted file, as illustrated in FIG. 3F. Selecting “Back” 77 causes the processor to close folder 2 and return to the previous user interface 3D. Selecting “Mark” 75 marks a file as highlighted so that more than one file can be highlighted at a time.

FIG. 3F illustrates a graphical user interface 41 comprising a list 79 of the user selectable options associated with the highlighted files in folder 2. The list 79 comprises the options “Move”, “Copy”, Delete” and “Set as ‘To’ folder”. A user of the device 1 can select a file or a plurality of files for transfer to the user designated destination folder by selecting either “Move” or “Copy” from the list 79.

As the destination folder has already been designated by the user as folder 1, once the user has selected to either move or copy a file or a plurality of files the selected files will be automatically transferred from folder 2 to folder 1

When the file is being transferred information indicative of the destination of the file and/or the titles of the files being transferred may be presented to the user on the display 11.

Once the file or files have been transferred the processor 3 will determine whether or not there are any files remaining in folder 2. If there are files remaining in folder 2 then the processor 3 will control the display 11 to present the graphical user interface 41 comprising the list 71 of files stored in folder 2 as illustrated in FIG. 3E. The list 71 of files in folder 2 would be updated to account for the files which have been transferred. If there are no files remaining in folder 2 then the processor 3 will close folder 2 and control the display 11 to present the graphical user interface 41 illustrated in FIG. 3D.

A user may also be able to undesignate a folder as the destination folder using the options menu illustrated in FIG. 3G. The options menu illustrated in FIG. 3G can be accessed from the list 57 of folders illustrated in FIG. 3C. When the user selects options for folder 1, which is the folder currently designated as the destination folder, then the graphical user interface 41 comprising the list 81 of user selectable options associated with the designated destination folder is presented as illustrated in FIG. 3G.

The list 81 of options includes the option “clear destination folder”. When the user selects this option folder 1 is undesignated and the device 1 returns to the display 3A. As folder 1 is no longer the designated destination folder the icon 67 indicating folder 1 as the destination folder is no longer displayed.

FIGS. 4A to 4F illustrate a second embodiment of the invention in use. In this embodiment a user of the device 1 can designate a destination folder after the file to be transferred has been selected.

The graphical user interface 41 presented in FIG. 4A is the same as the user interface in FIG. 3A. It comprises the same icons 43, 45, 47 and 49, the same legends 51, 53 and 55 and the same list 57 of folders.

In FIG. 4A “Folder 1” is highlighted in the list. The user of the device 1 can use the user input device 9 to scroll through the list 57 so that the different folders in the list 57 become highlighted. In the graphical user interface 41 illustrated in FIG. 4B the user has scrolled through the list so that now “Folder 2” is highlighted.

When the user selects the legend “Open” 53 the processor 3 opens the highlighted folder and controls the display 11 to present the list 71 of files stored within the highlighted folder, folder 2, as illustrated in FIG. 4C. As in the previous embodiment the legends “Options” 73, “Mark” 75 and “Back” 77 are presented to the user. These legends have the same function as in the previous embodiment so that when the user selects “Options” the display presents the list 79 of options associated with any highlighted or marked files. The list 79 of options is illustrated in FIG. 4D.

A user of the device 1 can select a file or a plurality of files for transfer to the user designated destination folder by selecting either “Move” or “Copy” from the list 79. In this embodiment the destination folder has not been designated so when the processor 3 determines that a user has selected a file or files to be transferred the processor 3 will enable a user to designate a destination folder by controlling the display 11 to present the graphical user interface 41 illustrated in FIG. 3E. The graphical user interface 41 in FIG. 3E comprises a list 91 of the candidate folders available to be designated as the destination folder. As the file to be transferred is currently in folder 2, folder 2 is not contained in the list 91 of candidate destination folders.

A user can designate the destination folder by scrolling the list 91 of folders until the correct folder is highlighted and then selecting the legend “select” 63.

Once a user has designated a destination folder the file or files selected for transfer are transferred to the designated destination folder. As the file is being transferred a message may be presented on the display 11 indicating the title of the file or files being transferred and/or the destination folder to which the files are being transferred.

Once the files have been transferred the processor 3 will determine whether or not there are any files left in folder 2. If there are any files left in folder 2 then the processor 3 will return to the list 71 of files in folder 2 and will control the display 11 to present the graphical user interface 41 illustrated in FIG. 4C. The list 71 of files in folder 2 would be updated to account for the files which have been transferred. If there are no files left in folder 2 then the processor 3 will close folder 2 and will control the display 11 to present the graphical user interface 41 illustrated in FIG. 4F which comprises the list 57 of the folders with an icon 67 indicating that folder 1 is now the designated destination folder.

The blocks illustrated in FIG. 2 may represent steps in a method and/or sections of code in the computer program 7 the illustration of a particular order to the blocks does not necessarily imply that there is a required or preferred order for the blocks and the order and arrangement of the blocks may be varied.

Although embodiments of the present invention have been described in the preceding paragraphs with reference to various examples, it should be appreciated that modifications to the examples given can be made without departing from the scope of the invention as claimed. For example, if a user wishes to transfer a file from a folder and a suitable destination folder does not exist, the user interface may enable a user to create a new folder.

Features described in the preceding description may be used in combinations other than the combinations explicitly described.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. An apparatus comprising:
a memory for storing files in a storage system comprising a plurality of folders;
a display for presenting the plurality of folders and the files stored in the plurality of folders to a user of the apparatus;
a user input device for enabling a user to designate a folder as a destination folder and for enabling a user to select a file to be transferred from a first folder to the designated destination folder;
a processor configured to determine, in response to user selection of a file in a first folder, if a destination folder has been designated by a user and, if a destination folder has been designated by a user, to transfer the selected file from the first folder to the designated destination folder, and if a destination folder has not been designated by a user to enable a user to designate a destination folder and to transfer the selected file to the designated destination folder.

2. An apparatus as claimed in claim 1 wherein a file may be transferred from the first folder to the destination folder by moving the file.

3. An apparatus as claimed in claim 1 wherein a file may be transferred from the first folder to the destination folder by copying the file.

4. An apparatus as claimed in claim 1 wherein once a file has been transferred to the designated folder the folder remains designated so that any subsequent files selected for transfer will be transferred to the designated folder.

5. An apparatus as claimed in claim 1 wherein the user input device enables a user to undesignate a folder as the destination folder.

6. An apparatus as claimed in claim 1 wherein the display is configured to present an icon to a user to indicate the user designated folder as the destination folder when a user designates a folder as the destination folder.

7. An apparatus as claimed in claim 1 wherein the display is configured to present to a user information indicative of the destination of the file when the file is being transferred from the first folder to the destination folder.

8. An apparatus as claimed in claim 1 wherein the user interface enables a user to select a plurality of files to be transferred from the first folder to the designated destination folder.

9. A method comprising:
storing files in a storage system comprising a plurality of folders on an electronic apparatus;
selecting a file to be transferred from a first folder;
in response to selection of the file determining if a destination folder has been designated by a user; and
if a destination folder has been designated by a user, transferring the selected file from the first folder to the designated destination folder, and if a destination folder has not been designated by a user, enabling a user to designate a destination folder and transfer the selected file to the designated destination folder.

10. A method as claimed in claim 9 wherein a file may be transferred from the first folder to the destination folder by moving the file.

11. A method as claimed in claim 9 wherein a file may be transferred from the first folder to the destination folder by copying the file.

12. A method as claimed in claim 9 wherein once a file has been transferred to the designated folder the folder remains designated so that any subsequent files selected for transfer will be transferred to the designated folder.

13. A method as claimed in claim 9 wherein a user can undesignate a folder as the destination folder.

14. A method as claimed in claim 9 wherein when a user designates a folder as the destination folder an icon is presented to a user to indicate the user designated folder as the destination folder.

15. A method as claimed in claim 9 wherein when the file is being transferred from the first folder to the destination folder information indicative of the destination of the file is presented to a user.

16. A method as claimed in claim 9 wherein a user selects a plurality of files to be transferred from the first folder.

17. A computer program comprising program instructions for controlling an apparatus, the apparatus comprising, a memory for storing files in a storage system comprising a plurality of folders, a display for presenting the plurality of folders and the files stored in the plurality of folders to a user of the apparatus, and a user input device for enabling a user to designate a folder as a destination folder and for enabling a user to select a file to be transferred from a first folder to the designated destination folder, the program instructions providing, when loaded into a processor:
means for determining, in response to selection of a file stored in a first folder, if a destination folder has been designated by a user; and if a destination folder has been designated by a user, means for transferring the selected file from the first folder to the designated destination folder, and if a destination folder has not been designated by a user, means for enabling a user to designate a destination folder and transfer the selected file to the designated destination folder.

18. A physical entity embodying the computer program as claimed in claim 17.

19. An electromagnetic carrier signal carrying the computer program as claimed in claim 17.

20. A computer program comprising program instructions for causing a computer to perform the method of claim 9.

21. A user interface comprising:
a display for presenting a plurality files stored in a storage system comprising a plurality of folders;
a user input device for enabling a user to designate a folder as a destination folder and for enabling a user to select a file to be transferred from a first folder to the designated destination folder;
wherein, in response to user selection of a file in a first folder, if a destination folder has been designated by a user the selected file is transferred from the first folder to the destination folder and if a destination folder has not been designated the user interface enables a user to designate a destination folder and transfer the selected fie to the designated destination folder.

22. An apparatus comprising:
a memory for storing files in a storage system comprising a plurality of folders;
a display for presenting the plurality of folders and the files stored in the plurality of folders to a user of the apparatus;
a user input device for enabling a user to designate a folder as a destination folder and for enabling a user to select a file to be transferred from a first folder to the designated destination folder;
a processor configured, in response to user selection of a file in a first folder, to automatically transfer a file from the first folder to the user designated destination folder.

23. An apparatus as claimed in claim 22 wherein the automatic transfer of the file does not require any further user input after the selection of the file.

24. An apparatus as claimed in claim 22 wherein the destination folder is designated before the file to be transferred from the first folder is selected.

25. An apparatus as claimed in claim 22 wherein the destination folder is designated after the file to be transferred from the first folder is selected and the folder remains designated as the destination folder so that any subsequent files selected for transfer will be transferred to the designated folder.
